(19) United States
(12) Patent Application Publication
(10) Pub. No.: US 2011/0232908 A1
(43) Pub. Date: Sep. 29, 2011

(54) ADDITIVE AND METHOD FOR SERVICING SUBTERRANEAN WELLS

(76) Inventors: Lionel Laza, Katy, TX (US); Sehgal Gopal, Richmond, TX (US); Orlando Tirado, Rock Springs, WY (US); Colin Archer, Rock Springs, WY (US); Emmanuel Therond, Houston, TX (US); Paul George, Sugar Land, TX (US)

(21) Appl. No.: 12/730,308

(22) Filed: Mar. 24, 2010

(51) Int. Cl. E21B 43/16; C09K 8/58

(52) U.S. Cl. 166/305.1; 507/271; 507/140; 106/816; 106/638

(57) ABSTRACT

Disclosed is a weighting agent comprising processed taconite, and methods of applying the weighting agents during the completion of subterranean wells. The processed taconite is ground such that the particle-size distribution is comparable to and compatible with other suspended solids in fluids such as, but not limited to, drilling fluids, lost-circulation-control fluids, spacer fluids, cement slurries and temporary pills.

### BACKGROUND OF THE INVENTION

The statements in this section merely provide background information related to the present disclosure and may not constitute prior art.

This invention relates to methods for servicing subterranean wells, in particular, fluid compositions and methods for drilling and cementing.

During construction of a subterranean well, operators may be confronted with high formation-pore pressures, unstable wellbores, and deformable or plastic formations. Maintaining well control under these circumstances may be achieved by using drilling fluids, spacer fluids and cement slurries that exert high hydrostatic pressures. It is not unusual for operators to employ fluids with densities exceeding 1860 kg/m³ (18.0 lbm/gal).

One method of increasing the fluid density is to reduce the volume of the liquid phase. To maintain pumpability, the addition of a dispersant is usually required. The principal disadvantage of reduced-fluid systems is the difficulty of simultaneously achieving adequate fluid-loss control, acceptable rheological properties, and fluid stability (i.e., little or no solids settling or sedimentation).

Another method of increasing the fluid density comprises the addition of materials with a high specific gravity. Such materials, known in the art as “weighting agents,” should meet several criteria to be acceptable. The particle-size distribution of the weighting agent must be compatible with that of the other solids in the fluid. Large particles tend to settle out, while small particles tend to increase fluid viscosity. The mixing-fluid requirement must be low. The weighting agent should not interfere with chemical processes taking place in the fluid (e.g., cement hydration).

The most common weighting agents for well-construction fluids include ilmenite (FeTiO₃; SG=4.45), hematite (Fe₂O₃; SG=4.95), barite (BaSO₄; SG=4.33) and magnesium tetraoxide (Mn₃O₄; SG=4.84). Depending on the mixing-fluid concentration, these weighting agents may allow operators to prepare pumpable systems with densities up to about 3000 kg/m³ (25 lbm/gal).

In recent years certain weighting agents, ilmenite and hematite in particular, have become increasingly scarce and costly. In addition, some commercially available ground hematites contain a significant amount of magnetic iron oxide, which may stick to tubulars and interfere with some downhole-evaluation measurements involving magnetic sensors. It is therefore desirable to expand the family of weighting agents for well-construction applications and reduce interference with downhole measurement techniques.

### SUMMARY OF THE INVENTION

The objective of this patent application is to disclose a weighting agent comprising processed taconite, and methods of applying the weighting agents during the completion of subterranean wells. The processed taconite is ground such that the particle size distribution is comparable to and compatible with other suspended solids in drilling fluids, lost-circulation-control fluids, spacer fluids, cement slurries and temporary pills.

Processed taconite is comprised mainly of hematite and residual silicates. The concentration of magnetic particles is lower than that found in other commercial hematite sources. The specific gravity is approximately 4.85.

One method of applying the disclosed invention is to add processed taconite to well-construction fluids, either in powder form or as a slurry. The processed taconite-laden fluid is then pumped into and circulated within the subterranean well.

### DETAILED DESCRIPTION

At the outset, it should be noted that in the development of any such actual embodiment, numerous implementation-specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary of the invention and this detailed description, each numerical value should be read once as modified by the term “about” (unless already expressly so modified), and then read again as not so modified unless otherwise indicated in context. Also, in the summary of the invention and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possessed knowledge of the entire range and all points within the range.

During construction of a subterranean well, operators may be confronted with high formation-pore pressures, unstable wellbores, and deformable or plastic formations. Maintaining well control under these circumstances may be achieved by using drilling fluids, spacer fluids and cement slurries that exert high hydrostatic pressures. It is not unusual for operators to employ fluids with densities exceeding 1860 kg/m³ (18.0 lbm/gal). The fluids may be water-base, oil-base or emulsions.

One method of increasing the fluid density is to reduce the volume of the liquid phase. To maintain pumpability, the addition of a dispersant is usually required. The principal disadvantage of reduced-fluid systems is the difficulty of simultaneously achieving adequate fluid-loss control, acceptable rheological properties, and fluid stability (i.e., little or no solids settling or sedimentation).

Another method of increasing the fluid density comprises the addition of materials with a high specific gravity. Such materials, known in the art as “weighting agents,” should meet several criteria to be acceptable. The particle-size distribution of the weighting agent must be compatible with that of the other solids in the fluid. Large particles tend to settle out, while small particles tend to increase fluid viscosity. The mixing-fluid requirement must be low. The weighting agent should not interfere with chemical processes taking place in the fluid (e.g., cement hydration).

The most common weighting agents for well-construction fluids include ilmenite (FeTiO₃; SG=4.45), hematite (Fe₂O₃; SG=4.95), barite (BaSO₄; SG=4.33) and magnesium tetraoxide (Mn₃O₄; SG=4.84). Depending on the mixing-fluid concentration, these weighting agents may allow operators to prepare pumpable systems with densities up to about 3000 kg/m³ (25 lbm/gal).

In recent years certain weighting agents, ilmenite and hematite in particular, have become increasingly scarce and costly. In addition, some commercially available ground hematites contain a significant amount of magnetic iron oxide, which can stick to tubulars and interfere with some downhole-evaluation measurements involving magnetic sensors. It is therefore desirable to expand the family of weighting agents for well-construction applications and reduce interference with downhole measurement techniques. It is also desirable to provide a method for substituting hematite, barite or magnesium tetraoxide in well-construction fluids comprising the step of adding taconite instead of said hematite, barite or magnesium tetraoxide in a quantity suitable to fulfill an equivalent performance as obtained with hematite, barite or magnesium tetraoxide compounds.

The objective of this patent application is to disclose a weighting agent comprising processed taconite, and methods of applying the weighting agents during the completion of subterranean wells. The processed taconite is ground such that the particle size distribution is comparable to and compatible with other suspended solids in drilling fluids, lost-circulation-control fluids, spacer fluids, cement slurries and temporary pills.

Taconite is an iron-bearing, high-silica, flint-like sedimentary rock. It is a low-grade iron ore comprising alternating bands of iron-rich layers and shale or chert layers. The iron is in the form of magnetite, and its abundance is generally 25%-30% by weight. Taconite processing involves grinding the ore into a fine powder, magnetically separating the iron-bearing particles, adding bentonite and limestone as a flux, and forming pellets that contain about 65 wt % iron. The pellets are then heated to about 1288° C. (2350° F.) in a kiln to oxidize the magnetite. The concentration of magnetic particles in processed taconite is lower than that found in commercial hematite sources. The specific gravity is approximately 4.9.

Depending on the particle-size distribution of the other solids in, for example, a drilling fluid, lost-circulation-control fluid, spacer fluid, cement slurry and temporary pill, the processed taconite may be ground to achieve various particle-size distributions. In general, the d₅₀ may vary between about 10 and 400 micrometers.

Applying the disclosed invention in a subterranean well comprises adding processed taconite to a well-construction fluid chosen from, but not limited to, the list comprising a drilling fluid, spacer fluid and a cement slurry. The processed taconite increases the density of the fluid, and may be in the form of a powder or a slurry. The resulting fluid may be circulated in and out of the wellbore (during a drilling operation, when pumping a spacer fluid during a cementing operation, and placing a temporary pill), placed in the annular region between the tubulars and the formation wall (during a cementing operation), and placed permanently in the well (during remedial cementing, plugging and lost-circulation-control operations)

The following example serves to further illustrate the invention. The materials used in the examples are commonly used in the well cementing industry.

### EXAMPLE 1

Two grams of commercially available ground hematite (Hematite, medium grade available from Densimix, Inc., Houston Tex.), and two grams of ground processed taconite were weighed in separate plastic weighing boats. The particle-size distributions were similar. Less than 5 wt % of particles were larger than 50 mesh; at least 40 wt % of particles fell within the 50 to 400-mesh range; 20-60 wt % of particles were smaller than 400 mesh. A magnet was applied to separate the magnetic particles from the samples.

After magnetic separation, the residual material was weighed. The magnet removed 35 wt % of particles from the ground-hematite sample, and 9 wt % of particles from the processed taconite sample.

We claim:

1. A weighting agent for increasing the density of fluids employed during the servicing of subterranean wells, the weighting agent comprising processed taconite.

2. The agent of claim 1, wherein the fluids include one or more members selected from the list consisting of drilling fluids, lost-circulation-control fluids, spacer fluids, cement slurries and temporary pills.

3. The agent of claim 2, wherein the fluids contain one or more members from the list consisting of water and oil.

4. The agent of claim 1, wherein the average particle size (d₅₀) of the processed taconite is between 10 and 400 micrometers.

5. The agent of claim 1, wherein the processed taconite is in the form of a powder or a slurry.

6. A method of servicing a subterranean well comprising:
i. adding processed taconite to a fluid, thereby increasing density of the fluid; and
ii. pumping the resulting taconite-laden fluid into the subterranean well.

7. The method of claim 6, further comprising circulating the taconite-laden fluid out of the subterranean well.

8. The method of claim 6, further comprising placing the taconite-laden fluid in the annular region between the tubulars and the formation wall.

9. The method of claim 6, wherein the fluid includes one or more members selected from the group consisting of drilling fluids, lost-circulation-control fluids, spacer fluids, cement slurries and temporary pills.

10. The method of claim 9, wherein the fluids contain one or more members selected from the group consisting of water and oil.

11. The method of claim 6, wherein the average particle size (d₅₀) of the processed taconite is between 10 and 400 micrometers.

12. The method of claim 6, wherein the processed taconite is in the form of a powder or a slurry.

13. A method for substituting conventional weighting agent in well-construction fluids comprising adding taconite instead of said conventional weighting agent in a quantity suitable to fulfill an equivalent performance as obtained with said conventional weighting agent.

14. A method according to claim 13 wherein the conventional weighting agent is hematite.

15. A method according to claim 13 wherein the conventional weighting agent is barite.

16. A method according to claim 13 wherein the conventional weighting agent is magnesium tetraoxide.
